(19) United States
(12) Patent Application Publication
(10) Pub. No.: US 2013/0103435 A1
(43) Pub. Date: Apr. 25, 2013

(54) METHOD AND SYSTEM FOR BOOKING TRAVEL TICKETS

(71) Applicant: Gautam Narayan Chhabria, Mumbai (IN)

(72) Inventor: Gautam Narayan Chhabria, Mumbai (IN)

(21) Appl. No.: 13/634,564

(22) PCT Filed: Oct. 6, 2010
(86) PCT No.: PCT/IN2010/000663

§ 371 Date: Nov. 8, 2012

(30) Foreign Application Priority Data
Mar. 26, 2010 (IN) 854/MUM/2010

(51) Int. Cl. G06Q 10/02

(52) U.S. Cl. CPC G06Q 10/02
USPC 705/5

(57) ABSTRACT

A system for booking travel tickets in an airplane includes an interface, and a client server having a bid receiving unit, an evaluating unit, and a booking unit. The interface is configured to display a set of travel information (corresponding to one or more pre-identified travelers) to one or more users. The bid receiving unit is configured to receive one or more bids from the users for a travel ticket corresponding to the displayed set of travel information. The evaluating unit is in communication with the bid receiving unit, and is configured to identify at least one bid from the bids as a winning bid and a corresponding user as a winning bidder. The booking unit is configured to communicate with one or more of airline servers and the evaluating unit, and to book the travel ticket. Further, disclosed is a method for booking travel tickets in an airplane.

### FIELD OF THE DISCLOSURE

The present disclosure generally relates to a method and a system for booking travel tickets, and, more particularly, to a method and a system for booking travel tickets corresponding to travel information of one or more pre-identified travelers.

### BACKGROUND OF THE DISCLOSURE

Individuals travel from one location to another for various reasons, such as recreation, tourism, meetings and the like. Such travelling may be done through various modes of transport, such as commercial airplanes, helicopters, trains, buses, boats, ships and the like. While travelling, the air-travelers generally book traveling arrangements well in advance. For booking travel tickets, for example air tickets, air-travelers go to airline offices, or contact travel agents. In some cases, the air-travelers may also book the travel tickets on websites authorized by airlines. However, in such booking of the air tickets, the air-travelers may be unaware about details of other co-travelers in the airplanes. Therefore, in such booking of travel tickets, the travelers may be devoid of an opportunity of selecting a particular co-traveler next to whom he/she may prefer to be seated.

Further, celebrities, such as entertainment personalities, sportsmen and the like, may also travel through the airplanes carrying other air-travelers. Accordingly, the air-travelers may be interested in availing an opportunity to sit near the celebrities. Sitting with the celebrities may provide air travelers with an opportunity to spend invaluable time interacting with the celebrities, exchanging views, seeking opinions, and learning from their experience. Few air-travelers may further be interested in availing an opportunity to sit next to the celebrities even by paying a premium amount for their air tickets.

However, any information about the celebrities traveling on an airplane is generally unavailable to the air-travelers, and therefore, the air-travelers may remain devoid of an opportunity of selecting a particular celebrity next to whom he/she may wish to be seated.

### SUMMARY OF THE DISCLOSURE

In one aspect, the present disclosure provides one embodiment of a method for booking travel tickets in an airplane (hereinafter referred to as “method”). The method includes presenting a set of travel information to one or more users. The set of travel information may correspond to one or more pre-identified travelers. The method may further include receiving one or more bids from the one or more users for a travel ticket corresponding to the presented set of travel information. Further, the method may include identifying at least one bid of the one or more bids as a winning bid and a corresponding user as a winning bidder. Further, the method may include booking the travel ticket corresponding to the presented set of travel information for the winning bidder.

In another aspect, the present invention provides a method for booking a travel ticket. The method includes presenting a set of travel information to one or more users. The set of travel information corresponds to one or more pre-identified travelers. Further, the method includes identifying the one or more users booking one or more travel tickets. Furthermore, the method includes reserving an additional travel ticket based on the identification. The method further includes receiving one or more bids from the one or more users for a travel plan corresponding to the presented set of travel information. After the receipt of the bids, the method includes identifying at least one bid from the one or more bids as a winning bid and a corresponding bidder as a winning bidder. After the determination of the winning bidder, the method includes receiving an amount from the winning bidder, the amount corresponding to the winning bid. After the receipt of the amount from the winning bidder, the method includes assigning the additional ticket to the winning bidder.

In yet another aspect, the present invention provides a method for booking, a travel ticket. The method includes presenting a set of travel information to one or more users. The set of travel information corresponds to one or more pre-identified travelers. Further, the method includes enquiring the one or more users to participate in a lucky draw. Furthermore, the method includes conducting the lucky draw to identify a winner, and booking the travel ticket for the winner.

In yet another aspect, the present disclosure provides a system for booking travel tickets in an airplane (hereinafter referred to as system). The system includes an interface configured to display a set of travel information to one or more users. The set of travel information may correspond to one or more pre-identified travelers. The system may further include a client server in communication with the interface. The client server includes a bid receiving unit configured to receive one or more bids from the one or more users for a travel ticket corresponding to the displayed set of travel information. The client server may further include an evaluating unit in communication with the bid receiving unit. The evaluating unit may be configured to identify at least one bid from the one or more bids as a winning bid and a corresponding user as a winning bidder. Further, the client server may include a booking unit configured to communicate with one or more of airline servers and the evaluating unit. The booking unit may be capable of booking the travel ticket corresponding to the displayed set of travel information.

### BRIEF DESCRIPTION OF THE DRAWINGS

The advantages and features of the present disclosure will become better understood with reference to the following detailed description and claims taken in conjunction with the accompanying drawing, in which:

FIG. 1 is a flow diagram of a method for booking travel tickets, according to an embodiment of the present disclosure;

FIG. 2 is a flow diagram of a method for identifying at least one bid as a winning bid, according to an embodiment of the present disclosure;

FIG. 3 is a flow diagram of a method, for booking travel tickets, according to another embodiment of the present disclosure;

FIG. 4 is a flow diagram of a method for booking travel tickets, according to another embodiment of the present disclosure;

FIG. 5 is a block diagram of a system for booking travel tickets, according to an embodiment of the present disclosure; and,

FIG. 6 is a block diagram of a system for booking travel tickets, according to another embodiment of the present disclosure.

### DETAILED DESCRIPTION OF THE DISCLOSURE

The exemplary embodiments described herein detail for illustrative purposes are subject to many variations in structure and design. It should be emphasized, however, that the present disclosure is not limited to a particular method and system of booking travel tickets as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The use of terms “including,” “comprising,” or “having” and variations thereof herein is meant to encompass the items listed thereafter and equivalents thereof as well as additional items. Further, the terms, “a” and “an” herein do not denote a limitation of quantity, but rather denote the presence of at least one of the referenced item.

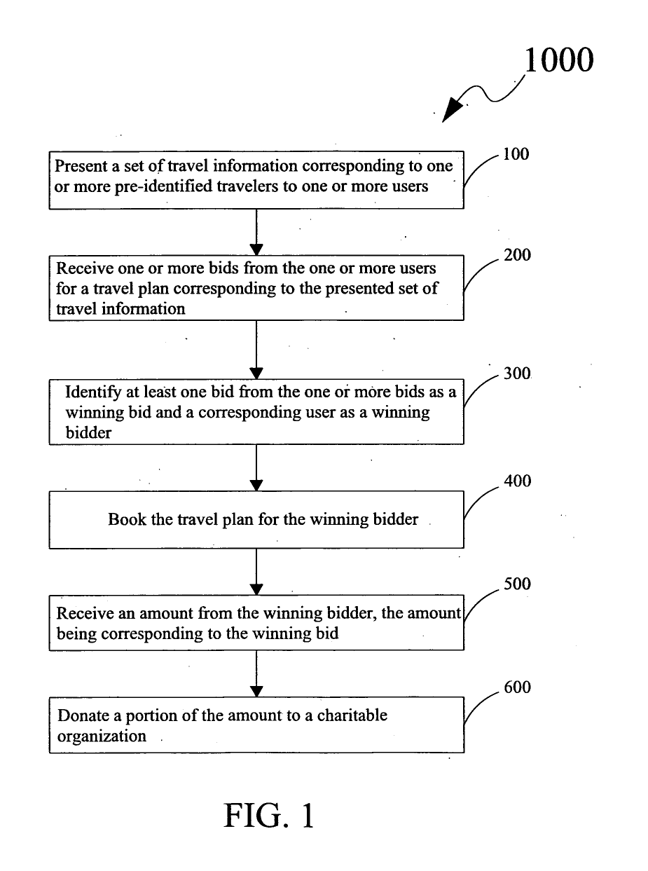

The present disclosure provides a method for booking travel tickets. Specifically, the present disclosure provides a method for booking travel tickets for seats adjacent to one or more pre-identified travelers traveling on airplanes. The term pre-identified travelers as used herein is intended to include celebrity travelers, such as businessmen, CEO's and CMD's of large corporations, heads of venture capital and private equity firms, politicians, models, sportsmen, sportswomen, VIPs, VVIP's, leaders, film actors, television actors, film producers, film directors, fashion designers, singers, musicians, prominent journalists, television anchors, artists, authors, spiritual leaders/gurus, prominent bureaucrats and the like. The term pre-identified travelers may further include acquaintances, such as friends, and colleagues of users intending to book the travel tickets. The present disclosure also provides a system for booking travel tickets. Specifically, the present disclosure provides a system for booking seats adjacent to one or more pre-identified travelers. The method and system of the present disclosure will now be described in details with reference to FIGS. 1-6. It should be understood that for the sake of brevity, the method and the system of the present disclosure may be described with reference to booking tickets for seats adjacent to that of one or more pre-identified travelers in airplanes. However, such explanation should not be construed as a limitation to the present disclosure. Therefore, the method and the system of the present disclosure may be applicable for booking travel tickets for seats in an airplane in which the one or more pre-identified travelers is traveling. Also, the method and the system of the present disclosure may be applicable for booking travel tickets for seats proximal to seats of one or more pre-identified travelers in an airplane. Similarly, it should be understood that the method and the system of the present disclosure may be applicable for booking travel tickets in other modes of travel, such as a helicopters, trains, buses, ships, boats, and other such modes of transportation.

FIG. 1 depicts a flow diagram of a method for booking travel tickets 1000 (hereinafter referred to as method 1000). The method 1000 for booking travel tickets may be performed in following steps, as depicted in FIG. 1. The method initiates at block 100, where one or more users are presented with a set of travel information corresponding to one or more pre-identified travelers.

The set of travel information may include names of the one or more pre-identified travelers. Exemplary names of one or more pre-identified travelers may include Sachin Tendulkar, N. R. Narayana Murthy, Aamir Khan, Shah Rukh Khan, Salman Khan, Akshay Kumar, Amitabh Bachchan, Abhishek Bachchan, Hrithik Roshan, Ranbir Kapoor, Deepika Padukone, Shashi Tharoor, Richard Gere, Imran Khan, Rahul Gandhi, Barack Obama, and Bill Gates.

The set of travel information may also include information regarding dates of travel corresponding to the one or more pre-identified travelers. The set of travel information may also include information regarding time of travel corresponding to the one or more pre-identified travelers. Further, the set of travel information may also include information regarding a set of location to be travelled by the one or more pre-identified travelers. Furthermore, the set of travel information may include information about mode of journey, such as a journey through a commercial plane, a private jet, and the like. Also, the set of travel information may include general information including but not limited to, age, marital status, one or more photograph, personal profile and the like, of the one or more pre-identified travelers. Specifically, the set of travel information may include flight details, such as, name of airline, flight/aircraft number and ticket details, such as seat number, of the one or more pre-identified travelers. However, it should be clearly understood that the aforementioned examples of the set of travel information should not be construed as a limitation to the present disclosure. Therefore, the set of travel information may also include other related information with respect to the one or more pre-identified travelers, such as a date of travel, a time of travel and a set of location to be travelled by the one or more pre-identified travelers.

More specifically, the presenting of the set of travel information, at block 100, may include displaying the set of travel information to the one or more users. The displaying of the set of travel information May be done on a web portal, on a wireless device, such as a mobile phone, and a public media, such as newspapers, radio, television. The set of travel information may also be displayed on integrated applications on social networking web portals, such as Facebook®, Myspace®, Linkedin®, and the like. In one embodiment of the present disclosure, the set of travel information may also be displayed on micro blogging website, such as Twitter. Preferably, the set of travel information may be displayed on dedicated web portals and third party web portals. Exemplary dedicated web portals may include domain names, such as www.flywithavip.com, www.flywithvip.com, www.flyingforcharity.com, www.flywithaceleb.com, www.flywithceleb.com, www.flywithcelebrity.com, www.flywithcelebrities.com, flywithceo.com, www.flywithavvip.com and www.flywithvvip.com.

Alternatively, the set of travel information may also be displayed on a dedicated web portal containing a name of the one or more the pre-identified travelers in the URL (Uniform Resource Locator) address, such as, www.flywithmrmurthy.com, www.flywithmrtata.com, and www.flywithmrgodrej.com. Additionally, the dedicated web portal containing the name of the eminent personality in the URL (Uniform Resource Locator) address may redirect to the dedicated web portal.

Optionally, such dedicated web portals may also include a conventional ticket booking interface having one or more advertisements integrated therewith.

It may be apparent to those skilled in the art that the set of travel information may alternatively be displayed through any other platforms than those listed herein. For example, the set of travel information may be displayed through public hoardings. Accordingly, any such display of the set of travel information shall not be considered to be disclosure limitation to the present disclosure.

Referring again to FIG. 1, after presenting the set of travel information, at block 100, the method 1000 may include receiving one or more bids from one or more of users for a travel ticket corresponding to the presented set of travel information, at block 200. The term bid as mentioned herein is intended to signify a conventional meaning.

The term travel ticket corresponding to the presented set of travel information may include a seat adjacent to a seat of the one or more pre-identified travelers. Alternatively, the travel ticket may include a seat proximate to the seat of the one or more pre-identified travelers. Further, the travel ticket may include any seat in a same airplane carrying the one or more pre-identified travelers.

Each of the one or more bids may be made by the one or more users. The each of the one or more bids may disclose a monetary amount the one or more users may be willing to pay for booking the travel ticket corresponding to the presented set of travel information or corresponding to the one or more pre-identified travelers.

It should be understood that the one or more bids may also be made on the dedicated web portal. Accordingly, such a web portal may be configured to allow bidding by the one or more users either by using a computer or by sending a short messaging service (sms) from a registered mobile number. Alternatively, the one or more bids may be made on an alternative communication platform, such as integrated applications to the social networking web portals. Optionally, the alternative communication platform may be an Interactive Voice Response (IVR) platform.

It should be understood herein that the one or more users may be registered on the dedicated web portal before making the bid. The registered user's submitted data may be cross verified by one or more external agencies. This increases the level of authenticity of the one or more users in the bidding process. Preferably, each such user may have a profile including information and a video thereof, available on the web portal or the social networking web portal. However, it should be understood that the users may even include unregistered individuals, and may in some cases also include any other individuals interested in booking the travel ticket corresponding to the presented set of travel information.

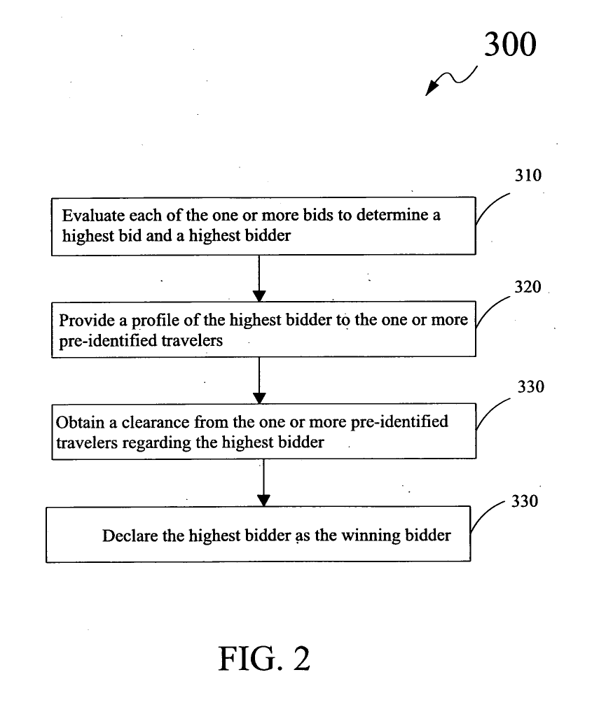

After the receipt of the one or more bids, at block 200, the method 1000 may include indentifying at least one bid of the one or more received bids as a winning bid and a corresponding user as a winning bidder. Such identification of the at least one bid of the one or more bids as a winning bid and a corresponding bidder is carried out in following three steps. These steps are depicted in FIG. 2.

As best shown in FIG. 2, at block 310, each of the one or more bids is evaluated based on a predefined criterion. The predefined criterion may include comparisons of the each of the one or more bids to determine a highest bid, a second highest bid, and remaining subsequently placed bids. This determines a highest bidder, a second highest bidder and remaining subsequently placed bidders. Thereafter, at block 320, the profile of the highest bidder is provided to the one or more pre-identified travelers. After identifying the highest bidder, at block 320, a clearance from the one or more pre-identified travelers is obtained, at block 330. The clearance from the one or more pre-identified travelers refers to an agreement from the one or more pre-identified travelers that the one or more pre-identified travelers is willing to travel with the highest bidder. In case the one or more pre-identified travelers rejects the profile of the highest bidder, a profile of the second highest bidder is provided to the one or more pre-identified travelers for obtaining the clearance thereof. In one embodiment, the evaluation of the one more bids may further include reviewing information and profiles of each of the one or more bidders, and verifying the same with a governmental agency, such as the department of police, or any other private agency.

In an alternative embodiment of the present disclosure, the profile of the highest bidder may be kept secret from the one or more pre-identified travelers. For this an additional premium may be charged from the highest bidder. However, in such a case, a prior consent may be obtained from the one or more pre-identified travelers informing them about such a situation.

Upon the clearance obtained from the one or more pre-identified travelers for the highest bidder, the highest bidder may be declared as the winning bidder, at block 340. Simultaneously, the winning bidder may be intimated about him/her being identified as the winning bidder. Such intimation may be provided by way of, email, Short Message Service (SMS) or through a display message on the dedicated web portal and/or a telephonic call.

After the identification of the at least one bid as a winning bid, at block 300, the method 1000 may include booking the travel ticket corresponding to the presented set of travel information, at block 400. The term booking as mentioned herein refers to setting aside the travel ticket for the winning bidder, and acknowledging that the winning bidder is authorized by the airline companies to travel alongside the one or more identified travelers. Further, it should be understood that booking the travel ticket may also be based on a shooting schedule of the one or more pre-identified travelers. For example, if the one or more celebrities are shooting in an international location, then the booking of the travel ticket may be based on the shooting schedule of the one or more celebrities. Accordingly, a user may be booked a seat adjacent to the one or more celebrities in the departure flight of the one or more celebrities. Further, the user may be booked a seat adjacent to the one or more celebrities in the return flight of the one or more celebrities. Also, arrangements may be made for the user to travel at same places and spots where the one or more celebrities are scheduled to shoot including being on the sets.

In one embodiment of the present disclosure, the step of booking may also be done by the winning bidder. Accordingly, the winning bidder when informed about his winning bid may book the travel ticket on his own. More specifically, the winning bidder when informed about his winning bid may be provided with an acknowledgment (a token), which the user may redeem at a travel agency, airline reservation counter or other similar airline ticket reservation centres. Alternatively, the user may redeem the acknowledgment at a third party website.

After the reservation of the travel ticket, at block 400, the method 100 may include receiving an amount, such as a monetary amount, corresponding to the winning bid, at block 500. Thereafter, at block 600, a portion of the monetary amount corresponding to the winning bid may be donated to one or more charitable organizations. Further, a remaining amount corresponding to the winning bid may be utilized elsewhere, for example in meeting travel expenses including cost of tickets and other expenses incurred in operating the dedicated web portal. Alternatively, another portion of the amount may also be utilized for subsidizing and waving off the cost of travel of the one or more pre-identified travelers. Additionally, a portion of the monetary amount may be offered to the one or more pre-identified travelers or utilized in subsidizing the travel tickets in their subsequent travels. In one embodiment, the one or more charitable organization may be selected by the one or more pre-identified travelers. In another embodiment, the one or more charitable organization may be selected by us.

The method 1000 may further include provisions for refunding the monetary amount during bidding by the one or more users (at block 100). Specifically, in case the one or more pre-identified travelers reschedule their dates of travel, or time of travel, the winning bidder may be provided with three options. As per the first option, the winning bidder may be offered a refund of the monetary amount. As per the second option, the winning bidder may be given an option of waiting for revised dates of travel, or time of travel, and then the winning bidder may be directly booked the travel ticket corresponding to the revised dates of travel, or time of travel. This ensures that the interests of the winning bidders are protected. As per third option, the winning bidder may be asked to maintain the monetary amount as interest free deposit. Further, as per the third option, the winning bidder may be given the option of using the monetary amount anytime in future against bidding for any other one or more pre-identified travelers.

Additionally, the method 1000 may include provisions wherein the one or more potential users may recommend or nominate the one or more pre-identified travelers with whom they wish to travel. These one or more potential users may be asked to provide details, such as email address and phone numbers of the one or more pre-identified travelers, for corroboration. However, it should be understood that the one or more users may be asked to place about a portion, such as 10-50 percent, deposit of the monetary amount they may potentially be ready to bid for booking the travel ticket corresponding to the recommended/nominated one or more pre-identified travelers.

Further; in the method 1000, in case a bidder is a young entrepreneur willing to bid for a travel ticket corresponding to one or more pre-identified travelers, such as a businessman, for discussing a potential business idea, discounts may be provided to the young entrepreneur in return of an equity stake in any company formed out of the business idea.

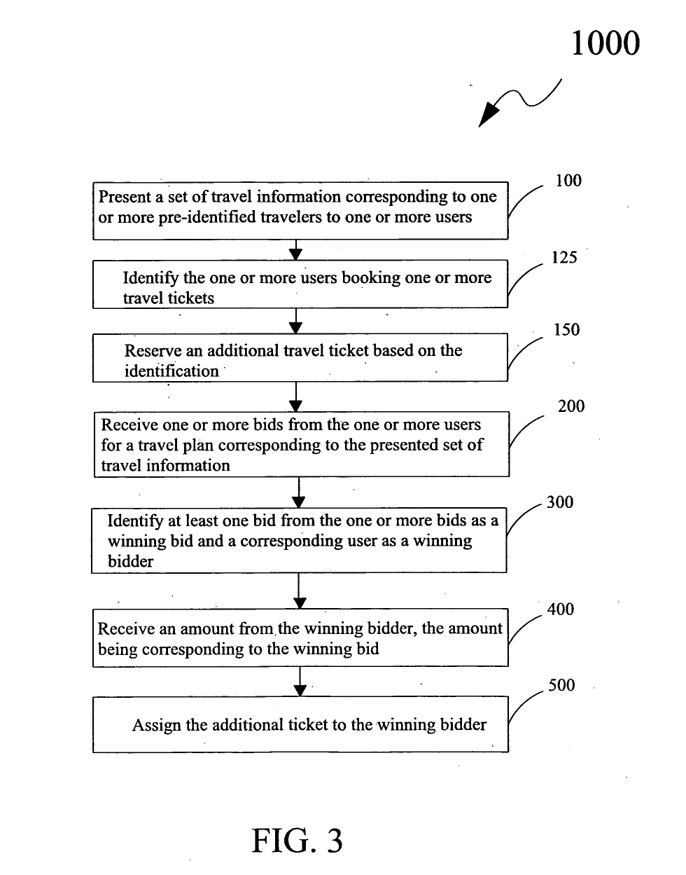

Also, the method 1000 may further include identifying the one or more users who may be booking the travel ticket at the website. Such embodiment is shown with reference to FIG. 3. As shown in FIG. 3, the method includes a step for identifying the one or more users booking travel tickets, at block 125. The identification may be implemented by a software code. Further, the method 1000 may include reserving an additional travel ticket based on the identification, at block 150. More specifically, if the one or more users is identified as a celebrity traveler, the software may book a travel ticket for a seat proximate, and more particularly adjacent, to the one or more pre-identified travelers. This additional travel ticket would be thereafter be auctioned, and given to the highest bidder. Thereafter, the method 1000 may include receiving one or more bids from the one or more users for a travel plan corresponding to the presented set of travel information, at 200. After receiving the bid, the method 1000 may include identifying at least one bid from the one or more bids as a winning bid and a corresponding user as a winning bidder, at 300. The method 1000 may thereafter include receiving an amount from the winning bidder, the amount being corresponding to the winning bid, at 400, followed by assigning the additional ticket to the winning bidder, at 500.

Additionally, the method 1000 may include providing optional discounts to frequently flying one or more users. Also, the method 1000 may include providing cash back options to the one or more users. These cash back options may be in form of credit points. These credit points may be redeemed later by the one or more users for booking seats adjacent to seats of the one or more pre-identified travelers. Moreover, the method 1000 may also include providing referral schemes to the one or more users.

Further, in one embodiment of the present disclosure, the method 1000 as described above may not include the steps of auctioning (steps 200 and 300). Accordingly, the method 1000 may include presenting a set of travel information to one or more users. The set of travel information corresponding to one or more pre-identified travelers. Further, the method 1000 may include booking the travel ticket corresponding to the presented set of travel information for at least one of the one or more pre-identified travelers.

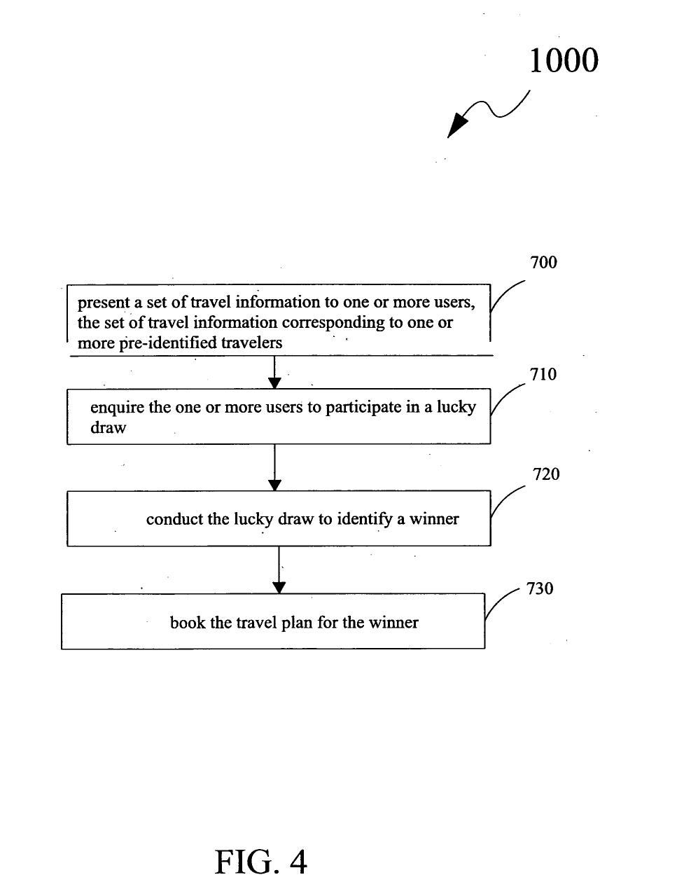

In another embodiment of the present disclosure, the method 1000 may include selecting a winner by means of a lucky draw. Such an embodiment is depicted in FIG. 4. As shown in FIG. 4, a set of travel information corresponding to one or more pre-identified travelers is presented to the one or more users, at block 700. Such information may be provided on a micro-blog, such as Twitter, and the one or more users, who are in fan lists of the one or more pre-identified travelers may be inquired to participate in a lucky draw, at 710. It should be understood that the one or more users may participate in the lucky draw after paying a participatory amount. Thereafter, a lucky draw may be conducted, at 720, to identify the winner. After the identification of the winner, the travel ticket may be booked for the selected winner adjacent to the one or more pre-identified travelers, at 730.

In another embodiment of the present disclosure, the method 1000 for selecting a winner by means of a lucky draw (as described in conjunction with FIG. 4) may include reserving the travel ticket after presenting the set of travel information to one or more users. More specifically, the method 1000 according to such an embodiment may include presenting a set of travel information to one or more users. The set of travel information corresponding to one or more pre-identified travelers, and reserving the travel ticket. Thereafter, the method includes enquiring the one or more users to participate in a lucky draw, conducting the lucky draw to identify a winner, and booking the travel plan assigning the travel ticket to the winner.

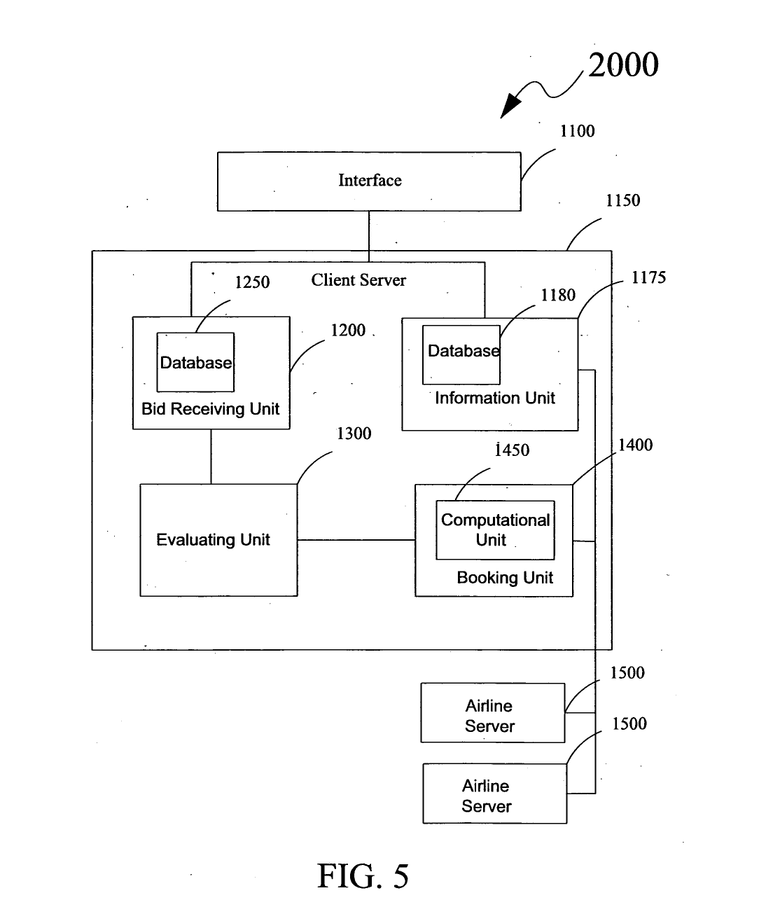

The method 1000 as described above may be implemented on a system. Such a system may now be explained in details with respect to FIG. 5. Referring now to FIG. 5, a system for booking travel tickets 2000 (hereinafter referred to as system 2000) is shown. The system 2000 includes an interface 1100. The interface 1100 may be configured to present a set of travel information corresponding to one or more pre-identified travelers to one or more users. Specifically, the interface 1100 may be configured to display the set of travel information corresponding to the one or more pre-identified travelers to the one or more users. Suitable examples of the interface 1100 may be web portals, however, it should be understood that such a website may additionally be customized to include a conventional booking interface, one or more advertisements and the like. Further, such a web portal may be configured to host video profiles of travelers in scheduled flights, bio data of travelers in scheduled flights, currency converting tools, bidding software and the like.

The system 2000 further includes a client server 1150 in communication with the interface 1100. The client server 1150 may include an information unit 1175 configured to retrieve the set of travel information corresponding to one or more pre-identified travelers from one or more airline servers 1500. The one or more airline servers 1500 as mentioned herein refers to conventional servers employed by different airliners to store and cater details about flight schedules, travelers list, ticket distributors, ticket availability, and other such information. In one embodiment, the client server 1150 may be configured to transmit the set of travel information corresponding to the one or more pre-identified travelers.

More specifically, the information unit 1175 may be configured to connect to the one or more airline servers 1500 after predetermined intervals of time, retrieve the set of travel information corresponding to the or more pre-identified travelers, and send it to the interface 1100. Further, the information unit 1175 may include a database 1180. The database 1180 may be configured to store the set of travel information retrieved by the information unit 1175.

The client server 1150 may further include a bid receiving unit 1200. The bid receiving unit 1200 may be configured to receive one or more bids from the one or more users for a travel ticket corresponding to the set of travel information of the one or more pre-identified travelers. More specifically, the one or more users on being presented with the set of travel information by the interface 1100 may bid for the travel ticket corresponding to the displayed set of travel information. Such bids may be received by the bid receiving unit 1200. The bid receiving unit 1200 may additionally include a database 1250 for storing the one or more bids.

The client server 1150 may further include an evaluating unit 1300. The evaluating unit 1300 may be in communication with the bid receiving unit 1200. The evaluating unit 1300 may be configured to identify at least one bid from the one or more bids for determining a winning bid and a corresponding winning bidder. Specifically, the evaluating unit 1300 retrieves the one or more bids stored in the database 1250 of the bid receiving unit 1200. Further, the evaluating unit 1300 may be configured to evaluate a monetary amount offered in each of the one or more bids to determine a highest bid and a corresponding bidder as a highest bidder. The evaluating unit 1300 may be further configured to transmit information about the highest bidder to the one or more pre-identified travelers for getting a clearance regarding the highest bidder. Upon getting the clearance from the one or more pre-identified travelers, the evaluating unit 1300 may be configured to declare the highest bidder as the winning bidder and a corresponding bid as the highest bid.

Alternatively, the evaluating unit 1300 may also be configured to identify the highest bidder as the winning bidder without an approval from the one or more pre-identified travelers.

Further, the client server 1150 includes a booking unit 1400. The booking unit 1400 may be configured to communicate with each of the one or more airline servers 1500, and the evaluating unit 1300.

The booking unit 1400 may be capable of booking the travel ticket corresponding to the set of travel information displayed by the interface 1100. Accordingly, the booking unit 1400 may include required firmware or software to perform the function. The booking unit 1400 may be capable of receiving the amount corresponding to the winning bid by the winning bidder. Upon receiving the amount, the travel ticket corresponding to the set of travel information may be booked for the winning bidder by the booking unit 1400. Further, the booking unit 1400 may further be configured to transfer a portion of the amount to one or more charitable organization.

Specifically, the booking unit 1400 may include a computation unit 1450. The computation unit 1450 may be configured to receive the amount from the winning bidder. The computational unit 1450 may be further configured to distribute a portion of biding amount received from the winning bidder to one of the one or more a charitable organization. Alternatively; the computational unit 1450 may be further configured to distribute a portion of biding amount received from the winning bidder to one or more pre-identified travelers. It should be clearly understood that the configuration of the computational unit 1450 as described above should not be construed as a limitation to the present disclosure.

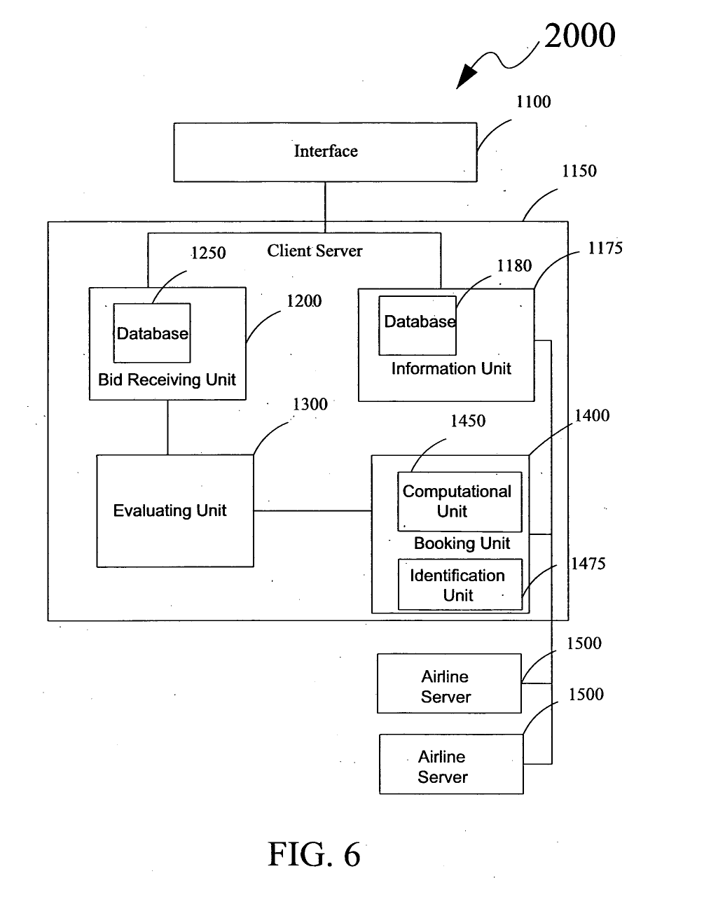

In one embodiment, the booking unit 1400 may additionally include an identification unit 1475 (as shown in FIG. 6) for identifying the one or more users using the interface 1100. The identification unit 1475 may be configured to identify the one or more users using the interface 1100. In case, the one or more users is one of the one or more pre-identified travelers, the booking unit 1400 may be configured to book an additional seat adjacent to the one of the one or more pre-identified traveler. This additional seat may thereafter be auctioned, and the bid receiving unit 1200 may be configured to receive bids from other one or more users for this additional seat.

In another embodiment of the present invention, the system 2000 may include the client server 1150 with features of collecting and storing as part of one of the one or more airline servers 1500. In such a case the system 2000 may only include the one or more airline servers 1500 communicably coupled to the interface 1100.

During utilization of the disclosed method and system, one or more bidders may be presented with a set of travel information corresponding to one or more pre-identified travelers. The information may be presented, and more specifically, displayed on the interface 1100. Thereafter, the one or more bidders may place bids for booking travel tickets for seats adjacent to the one or more pre-identified travelers. Whereupon, the one or more bids may be received by the bid receiving unit 1200. Further, the received one or more bids 1200 may further be evaluated to determine a winning bidder. The evaluation may be done by the evaluating unit 1300. Thereafter, the winning bidder may be booked a ticket of seats adjacent to the one or more pre-identified travelers by the booking unit 1400.

The present disclosure therefore provides a method for booking travel, such as the method for booking travel 1000. The present disclosure further provides a system for booking travel tickets, such as the system of booking travel tickets 2000. Each of the method 1000 and the system 2000, enable the one or more users to receive a set of travel information of one or more pre-identified travelers. The one or more users may bid for seats adjacent to the one or more pre-identified travelers. And upon identification the one or more user may be identified as a winning bidder. Accordingly, the disclosed method and system enable the winning bidder book the travel tickets adjacent to the one or more pre-identified travelers. Therefore, the method and system of the present disclosure allows the one or more users to book tickets for a seat adjacent to the one or more pre-identified travelers in an airplane, train, bus, boat, ship and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. (It is understood that various omission and substitutions of equivalents are contemplated as circumstance may suggest or render expedient, but such are intended to cover the application or implementation without departing from the spirit or scope of the claims of the present disclosure).

1. A method for booking a travel ticket, the method comprising:
presenting a set of travel information to one or more users, the set of travel information corresponding to one or more pre-identified travelers;
receiving one or more bids from the one or more users for a travel ticket corresponding to the presented set of travel information;
identifying at least one bid from the one or more bids as a winning bid and a corresponding user as a winning bidder; and
booking the travel ticket corresponding to the presented set of travel information for the winning bidder.

2. The method of claim 1 further comprising, receiving a monetary amount from the winning bidder, the monetary amount corresponding to the winning bid, and
donating a portion of the amount to a charitable organization.

3. The method of claim 1 further comprising,
identifying the one or more users booking one or more travel tickets; and
reserving an additional travel ticket based on the identification.

4. The method of claim 1, wherein presenting the set of travel information comprises providing at least one of
a name of one or more pre-identified travelers,
a name of an airline corresponding to the one or more pre-identified travelers,
a flight number of the airline,
a date of travel corresponding to the one or more pre-identified travelers,
a time of travel corresponding to the one or more pre-identified travelers, and
a set of one or more locations to be travelled to by the one or more pre-identified travelers.

5. The method of claim 1, wherein the one or more pre-identified travelers comprises one or more celebrities.

6. The method of claim 1, wherein the one or more pre-identified travelers comprises one or more acquaintances of the one or more users.

7. The method of claim 1, wherein presenting the set of travel information comprises displaying the set of travel information on at least one of a web portal, a wireless device, and a public media.

8. The method of claim 1, wherein receiving the one or more bids from the one or more users comprises identifying the one or more bids from the one or more users for booking the travel ticket corresponding to a seat in an airplane.

9. The method of claim 1, wherein receiving the one or more bids from the one or more users comprises identifying the one or more bids from the one or more users for booking the travel ticket corresponding to a seat in a train.

10. The method of claim 1, wherein receiving the one or more bids from the one or more users comprises identifying the one or more bids from the one or more users for booking the travel ticket for a seat adjacent to a seat of the one or more pre-identified travelers in an airplane.

11. The method of claim 1, wherein receiving the one or more bids from the one or more users comprises identifying the one or more bids from the one or more users for booking the travel ticket for a seat adjacent to a seat of the one or more pre-identified travelers in a train.

12. The method of claim 1, wherein receiving the one or more bids from the one or more users comprises identifying the one or more bids from the one or more users for booking the ticket for a seat proximate to a seat of the one or more pre-identified travelers in an airplane.

13. The method of claim 1, wherein receiving the one or more bids from the one or more users comprises identifying the one or more bids from the one or more users for booking the ticket for a seat proximate to a seat of the one or more pre-identified travelers in a train.

14. The method of claim 1, wherein identifying the at least one bid as the winning bid comprises,
evaluating each of the one or more bids to determine a highest bid and a highest bidder,
providing a profile of the highest bidder to the one or more pre-identified travelers,
obtaining a clearance from the one or more pre-identified travelers regarding the highest bidder, and
declaring the highest bidder as the winning bidder.

15. The method of claim 1, wherein the travel ticket comprises a travel ticket for at least one of a helicopter, a train, a boat, a ship and a bus.

16. The method of claim 1, wherein booking the travel ticket comprises booking the travel ticket based on a shooting schedule of the one or more pre-identified travelers.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A method for booking a travel ticket, the method comprising:
presenting a set of travel information to one or more users, the set of travel information corresponding to one or more pre-identified travelers;
inviting the one or more users to participate in a lucky draw;
conducting the lucky draw to identify a winner; and
booking the travel ticket for the winner.

32. (canceled)

33. A system for booking travel tickets in an airplane, the system comprising:
an interface configured to display a set of travel information corresponding to one or more pre-identified travelers; and
a client server in communication with the interface, the client server comprising,
a bid receiving unit configured to receive one or more bids from one or more users for a travel ticket corresponding to the displayed set of travel information,
an evaluating unit in communication with the bid receiving unit, the evaluating unit configured to identify at least one bid from the one or more bids as a winning bid and a corresponding user as a winning bidder, and
a booking unit configured to communicate with one or more of airline servers and the evaluating unit, the booking unit being capable of booking the travel ticket corresponding to the displayed set of travel information.

34. The system of claim 33, wherein the evaluating unit is further configured to,
evaluate each of the one or more bids to determine a highest bid and a highest bidder,
transmit a profile of the highest bidder to the one or more pre-identified travelers for getting a clearance regarding the booking by the highest bidder, and
declaring the highest bidder as the winning bidder.

35. The system of claim 33, wherein the booking unit comprises a receiving unit capable of receiving an amount corresponding to the winning bid from the winning bidder.

36. The system of claim 33, wherein the booking unit further comprises a computation unit configured to distribute a portion of the amount received from the winning bidder to one or more charitable organizations.

37. The system of claim 33, wherein the information unit further comprises a database to store the retrieved set of travel information.

38. The system of claim 33, wherein the client server further comprises an information unit configured to retrieve the set of travel information corresponding to one or more pre-identified travelers from the one or more airline servers.

39. The system of claim 33, wherein the booking unit includes an identification unit configured to identify the one or more users using the interface.

40. (canceled)

41. (canceled)

42. (canceled)

43. (canceled)
